(19) United States
(12) Patent Application Publication
(10) Pub. No.: US 2012/0102679 A1
(43) Pub. Date: May 3, 2012

(54) ADJUSTABLE SOCKET FOR FERRULE ROPE

(75) Inventors: Stephen P. Doan, Oregon City, OR (US); Brian C. Matlock, Porland, OR (US); Carel C. W. M. Verlinden, Beaverton, OR (US)

(73) Assignee: Columbia Steel Casting Co., Inc.

(21) Appl. No.: 13/027,110

(22) Filed: Feb. 14, 2011

Related U.S. Application Data
(60) Provisional application No. 61/409,026, filed on Nov. 1, 2010.

(51) Int. Cl. F16G 11/00

(52) U.S. Cl. 24/115 R

(57) ABSTRACT

An adjustable socket for receiving a ferrule rope comprises an elongated body, a primary stop, a channel and an adjustable stop. The primary stop comprises an opening in the body dimensioned larger than a diameter of a rope portion of the ferrule rope and smaller than a ferrule end of the ferrule rope, and a surface of the body adjacent the opening against which the ferrule end can bear. The channel is defined in communication with the opening and extending along the body. The channel has a cross sectional open area larger than the opening and is dimensioned to receive the ferrule end of the ferrule rope. The adjustable stop is selectively actuatable to define a secondary stop spaced from the primary stop along the channel and against which the ferrule end can bear, thereby changing a length of the ferrule rope.

### CROSS REFERENCE TO RELATED APPLICATION

This application claims the benefit of U.S. Provisional Patent Application No. 61/409,026 file Nov. 1, 2010, which is incorporated herein by reference.

### BACKGROUND

Some rope sockets are specially adapted to retain the ferruled ends of cable ropes, also called ferrule ropes, such as are used in dragline rigging applications. A conventional rope socket has an eye at one end, such as for receiving a pin of a pin connection, a body shaped to receive and retain one end of the rope and an opening at an opposite end to allow the other end of the rope to extend away from the ferrule rope socket. When in use, the ferruled end of the rope contacts a stop within the body, and the stop secures the rope against movement relative to the body.

In conventional dragline applications, one type of rope has one ferruled end and one wedge rope socket end. At times, it can be advantageous to adjust the length of a rope. Although the wedge rope socket is adjustable, it is difficult and time consuming to manipulate. As a result, many users simply choose not to adjust to length of ropes, and often tolerate ropes that are beyond their optimal lengths because the burden of shortening them is outweighed by their relatively short remaining useful lives. It would be beneficial to provide for easier adjustment in lengths of ropes to allow for proper dragline operation and full utilization of ropes.

### SUMMARY

Described below is a new adjustable ferrule rope socket assembly that provides for adjustment of rope length in a robust and convenient way.

According to one implementation, an adjustable socket for receiving a ferrule rope comprises an elongated body, a primary stop, a channel and an adjustable stop. The primary stop comprises an opening in the body dimensioned larger than a diameter of a rope portion of the ferrule rope and smaller than a ferrule end of the ferrule rope, and a surface of the body adjacent the opening against which the ferrule end can bear. The channel is defined in communication with the opening and extends along the body. The channel has a cross sectional open area larger than the opening and is dimensioned to receive the ferrule end of the ferrule rope. The adjustable stop is selectively actuatable to define a secondary stop spaced from the primary stop along the channel and against which the ferrule end can bear, thereby changing a length of the ferrule rope.

In some embodiments, the primary stop is positioned adjacent an end of the elongated body. The channel can comprise an enlarged mouth opening formed in a side of the body and dimensioned larger than the cross sectional open area of the channel and larger than the ferrule end of the ferrule rope.

The adjustable socket can comprise an eye extending from the body. The eye can extend from an end of the body.

The body of the adjustable socket can be formed with at least one pair of openings on opposite sides of the channel and aligned in a direction transverse to the channel, the openings being configured to receive a fastener. The openings can be positioned such that a fastener received in the openings can secure the adjustable stop in a storage position. The openings can be positioned such that a fastener received in the openings can secure a ferrule rope received in the socket against movement within the channel, such as longitudinal and/or rotational movement. The body can be formed with two sets of openings on opposite sides of the channel and aligned in a direction transverse to the channel, and wherein a first set of the openings is positioned to receive a fastener capable of securing a ferrule rope against the stop and the second set of openings is positioned to receive a fastener capable of securing the adjustable stop in a storage position.

In some implementations, the adjustable stop is channel-shaped. The adjustable stop can be dimensioned to be slidingly received in the channel of the adjustable socket. The adjustable stop can comprise at least one aperture dimensioned to receive a fastener. The adjustable stop can be dimensioned to have a functional length such that a first end of the adjustable stop bears against the stop, and an opposing second end of the adjustable stop is positioned at a selected distance away from the stop such that a ferrule rope engaging the adjustable stop instead of the stop is shortened as desired. The adjustable stop can be dimensioned to have a functional length of about 270 mm. The adjustable stop can have a length set to shorten the rope by about 1.5°.

Also described is a method of shortening a ferrule rope used an adjustable socket, comprising positioning a ferruled end of the ferrule rope against a stop at a first position relative to the socket, moving the ferrule rope from the first position to a second position spaced from the first position along the socket, and securing the ferrule rope in the second position. Positioning a ferruled end of the ferrule rope against a stop at a first position can comprise securing the ferruled end in place relative to the socket with a fastener. Securing the ferrule rope can comprise removing the fastener, moving the ferrule rope and the socket relative to each other until the ferrule rope is in the second position, and securing the ferrule rope in the second position relative to the socket with a fastener. Securing the ferrule rope in the second position can comprise abutting the ferrule end of the ferrule rope against the adjustable stop. The methods may also comprise removing the adjustable stop from a storage position on the socket by removing a fastener securing the adjustable stop to the socket in the storage position.

### BRIEF DESCRIPTION OF THE DRAWINGS

FIG. 1 is a top plan view of an embodiment of an adjustable socket showing a portion of a ferrule rope in a first position.

FIG. 2 is a sectioned side view of the adjustable socket and ferrule rope of FIG. 1.

FIG. 3 is a side view of the adjustable socket and ferrule rope of FIG. 1.

FIG. 4 is a perspective view of the adjustable socket and ferrule rope of FIG. 1.

FIG. 5 is a top plan view of the adjustable socket and ferrule rope of FIG. 1, except showing the ferrule rope in a second shortened position.

FIG. 6 is a sectioned side view of the adjustable socket and ferrule rope of FIG. 5.

FIG. 7 is a side view of the adjustable socket and ferrule rope of FIG. 5.

FIG. 8 is a perspective view of the adjustable socket and ferrule rope of FIG. 5.

### DETAILED DESCRIPTION

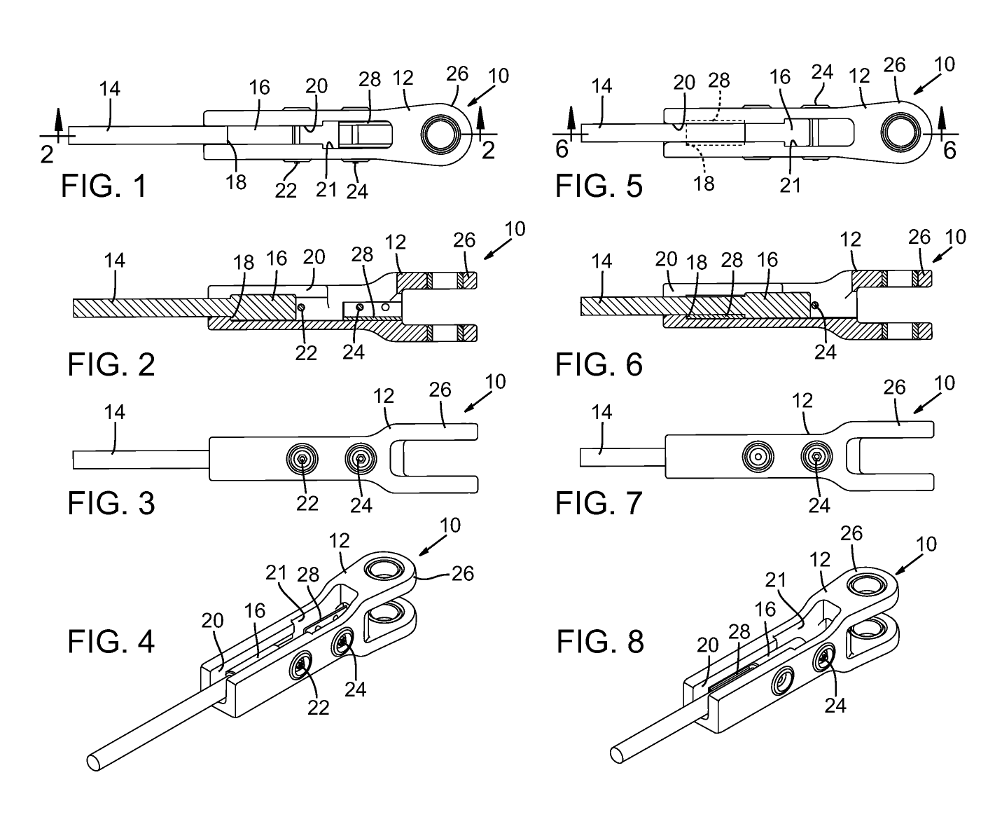

Referring to FIGS. 1-8, an adjustable socket and ferrule rope assembly 10 comprises an adjustable socket 12 and a wire rope 14 with a ferrule end, or ferrule rope (for ease of illustration, only a short length of the ferrule rope is shown in the drawings). The rope 14 has a ferruled end 16 larger than the diameter of the rope. The ferruled end 16 is shaped to bear against and be retained within the socket 12 by a stop 18 (see, e.g., FIG. 2) within a groove 20 formed in the elongated body of the socket. A mouth 21 in the groove 20, e.g., as shown in FIGS. 1 and 4, is sized larger than the rest of the groove 20, and large enough to receive the ferruled end 16, thus allowing the rope 14 to be installed in and removed from the ferrule socket 12. In the illustrated implementations, the socket 12 is formed with an eye 26 at one end.

FIGS. 1-4 show the assembly in a first condition providing for a standard length rope. As can be seen in FIGS. 1, 2 and 4, the ferruled end 16 is against the stop 18 and near the end of the adjustable socket 12. As best seen in FIG. 1, a first bolt 22 extends transversely through the groove 20 and is secured to prevent unintended movement of the ferruled end 16 within the groove 20 that could lead to inadvertent release of the rope 12. A second bolt 24 is also secured across the groove 20. As shown in FIGS. 1 and 2, the second bolt secures an adjustable stop or spacer 28 to the ferrule socket 12. The spacer 28, which has a hollow semicircular cross-section or other shape compatible with the groove 20, is not used in the first condition for a standard length rope.

FIGS. 5-8 show the ferrule socket assembly in a second condition providing for a shortened rope. According to one implementation, the assembly 10 is changed from a standard length rope to a shortened rope after elongation has occurred, e.g., as a result of wear in one or more components of the system. Shortening the length of the rope can help reconfigure the system so the geometry of the rigging more closely matches its ideal configuration.

To change from the standard length rope shown in FIGS. 1-4 to the shortened rope shown in FIGS. 5-8, (1) the first bolt 22 is removed, (2) the second bolt 24 is removed, (3) the ferruled end 16 of the rope 14 is unseated, and the rope 14 and/or the ferrule socket 12 are moved relative to each other until the spacer 28 can be inserted against the stop 18, (4) the rope 14 is moved back until the ferruled end 16 bears against the end of the spacer 28 (see, FIG. 6), and (5) the second bolt 24 is reinstalled to retain the rope 14 in place. Depending upon the particular geometry, inserting the spacer in step 3 may require that the ferruled end 16 is moved until it can be temporarily removed from the groove 20 through the mouth 21 to allow sufficient space for positioning the spacer 28.

Thus, the assembly 10 allows relatively easy reconfiguration in the field. Specifically, a rope can be shortened by simply removing bolt(s) with conventional tools, repositioning the rope and the spacer and then retightening the bolt. These steps can be performed relatively quickly, which will encourage users to adjust rope lengths to maintain optimal dragline digging efficiency.

In one implementation, the spacer is sized (i.e., its length is set) to provide about a 1.5° change in drag/dump circuit geometry. Using the spacer on both ends of the rope provides 3° of adjustment. In one implementation, ropes are removed from service after making the second adjustment to 3° and further adjustment is not required.

In one implementation, the spacer is sized to shorten the rope by about 270 mm. Of course, the spacer can be adapted to provide for shortening the rope by any suitable distance.

The socket 12 and the spacer 28 are preferably fabricated from high strength steel, although any suitable material can be substituted.

In view of the many possible embodiments to which the principles of the present disclosure can be applied, it should be recognized that the illustrated embodiments are only examples and should not be taken as limiting the scope of the following claims. We therefore claim all that comes within the scope and spirit of these claims.

1. An adjustable socket for receiving a ferrule rope, comprising:
an elongated body;
a primary stop comprising an opening in the body dimensioned larger than a diameter of a rope portion of the ferrule rope and smaller than a ferrule end of the ferrule rope, and a surface of the body adjacent the opening against which the ferrule end can bear;
a channel defined in communication with the opening and extending along the body, the channel having a cross sectional open area larger than the opening and being dimensioned to receive the ferrule end of the ferrule rope; and
an adjustable stop selectively actuatable to define a secondary stop spaced from the primary stop along the channel and against which the ferrule end can bear, thereby changing a length of the ferrule rope.

2. The adjustable socket of claim 1, wherein the primary stop is positioned adjacent an end of the elongated body.

3. The adjustable socket of claim 1, wherein the channel comprises an enlarged mouth opening formed in a side of the body and dimensioned larger than the cross sectional open area of the channel and larger than the ferrule end of the ferrule rope.

4. The adjustable socket of claim 1, further comprising an eye extending from the body.

5. The adjustable socket of claim 4, wherein the eye extends from an end of the body.

6. The adjustable socket of claim 1, wherein the body is formed with at least one pair of openings on opposite sides of the channel and aligned in a direction transverse to the channel, the openings being configured to receive a fastener.

7. The adjustable socket of claim 6, wherein the openings are positioned such that a fastener received in the openings can secure the adjustable stop in a storage position.

8. The adjustable socket of claim 6, wherein the openings are positioned such that a fastener received in the openings can secure a ferrule rope received in the socket against movement within the channel.

9. The adjustable socket of claim 6, wherein the body is formed with two sets of openings on opposite sides of the channel and aligned in a direction transverse to the channel, and wherein a first set of the openings is positioned to receive a fastener capable of securing a ferrule rope against the stop and the second set of openings is positioned to receive a fastener capable of securing the adjustable stop in a storage position.

10. The adjustable socket of claim 1, wherein the adjustable stop is channel-shaped.

11. The adjustable socket of claim 10, wherein the adjustable stop is dimensioned to be slidingly received in the channel of the adjustable socket.

12. The adjustable socket of claim 10, wherein the adjustable stop comprises at least one aperture dimensioned to receive a fastener.

13. The adjustable socket of claim 1, wherein the adjustable stop is dimensioned to have a functional length such that a first end of the adjustable stop bears against the stop, and an opposing second end of the adjustable stop is positioned at a selected distance away from the stop such that a ferrule rope engaging the adjustable stop instead of the stop is shortened as desired.

14. The adjustable socket of claim 13, wherein the adjustable stop is dimensioned to have a functional length of about 270 mm.

15. The adjustable socket of claim 13, wherein the adjustable stop has a length set to shorten the rope by about 1.5°.

16. A method of shortening a ferrule rope used an adjustable socket, comprising
positioning a ferruled end of the ferrule rope against a stop at a first position relative to the socket;
moving the ferrule rope from the first position to a second position spaced from the first position along the socket;
securing the ferrule rope in the second position; and
wherein the stop is a fixed stop, further comprising positioning an adjustable stop against the fixed stop, and wherein securing the ferrule rope in the second position comprises abutting the ferrule end of the ferrule rope against the adjustable stop.

17. The method of claim 16, wherein positioning a ferruled end of the ferrule rope against a stop at a first position comprises securing the ferruled end in place relative to the socket with a fastener.

18. The method of claim 16, wherein securing the ferrule rope comprises removing the fastener, moving the ferrule rope and the socket relative to each other until the ferrule rope is in the second position, and securing the ferrule rope in the second position relative to the socket with a fastener.

19. (canceled)

20. The method of claim 19, further comprising removing the adjustable stop from a storage position on the socket by removing a fastener securing the adjustable stop to the socket in the storage position.
